(19) United States
(12) Patent Application Publication
(10) Pub. No.: US 2016/0016428 A1
(43) Pub. Date: Jan. 21, 2016

(54) WHEEL COVER ASSEMBLY SYSTEM AND METHOD

(71) Applicant: Vahlco, LLC, New Egypt, NJ (US)

(72) Inventors: Taylor J. Weld, Lees Summit, MO (US); Fred Vahlsing, New Egypt, NJ (US)

(21) Appl. No.: 14/804,941

(22) Filed: Jul. 21, 2015

Related U.S. Application Data
(60) Provisional application No. 62/026,825, filed on Jul. 21, 2014.

(51) Int. Cl. B60B 7/06

(52) U.S. Cl. CPC B60B 7/06; B60B 2320/10

(57) ABSTRACT

The present disclosure provides for an improved system and method for adaptively coupling a wheel cover to a wheel comprising one or more mounting fixtures affixed to the rim of the wheel such that the wheel cover may be attached to the mounting fixtures. The system and method relate to a wheel cover assembly that can used to prevent dirt, mud or any type of debris from entering the wheel or may be merely decorative in nature. The present disclosure also describes various novel mechanisms to secure the wheel cover to the rim of the wheel. Additionally, the present disclosure provides for a wheel cover which extends over the outer periphery of a wheel rim for improved protection against debris intrusion and build-up.

### CROSS-REFERENCE TO RELATED APPLICATION

This application claims the benefit under 35 U.S.C. §119(e) of U.S. Provisional Patent Application No. 62/026,825, filed Jul. 21, 2014, which is incorporated by reference herein in its entirety.

### FIELD OF INVENTION

The present invention relates to an improved system and method for adaptively affixing a wheel cover to a wheel having one or more removable mounting fixtures. In particular, the present invention describes a novel wheel, wheel cover and various novel mechanisms to secure the wheel cover to the rim of the wheel such that the wheel cover may be attached to the mounting fixture(s). The wheel cover assembly of the present invention may be used to prevent outside material, such as dirt, mud, gravel, sand, or any other type of debris, from entering the wheel. In an embodiment, the wheel cover may be decorative in nature. The system and method of the present invention are particularly well-suited for affixing a wheel cover to any manufacturer's non-beadlock wheel regardless of the wheel construction.

### BACKGROUND

Wheel covers are used to prevent dirt or other materials from entering a wheel as well as for decorative purposes. Wheel covers are particularly useful in many automobile racing fields such as, for example, dirt track racing, rally racing or any type of off-road racing. Wheel covers are also particularly useful in conjunction with advanced automobile technologies, such as electric cars or self-driving cars. These vehicles may contain delicate equipment that needs to be protected from dirt and other materials, such as in, for example, wheel motors or electronic sensors. Wheel covers may be removable to access areas behind the attached cover, as might be necessary for accessing mounting fasteners that attach the wheel to the vehicle, for adjusting air pressure of the tire, or for accessing any sensitive equipment within the wheel. Indeed, wheel covers may also be used in any type of driving activity in which dirt, mud, gravel, sand, debris or the like may enter the wheel. Such covers are helpful in preventing matter from entering the wheel, which can damage sensitive equipment in the wheel, or can cause the wheel to become unbalanced and negatively affect the safety and performance of the vehicle.

Existing wheel cover mounting fixtures are not typically adjustable and cannot reasonably be adapted to fit any type of make and model of wheel. Such wheel cover mounting fixtures are often installed onto the wheel during the wheel's manufacture and severely limit, if not prevent entirely, any modification of the wheel cover mounting assembly. FIGS. 1A and 1B illustrate an example of a prior art wheel cover assembly 100 of unitary construction. Such wheel cover assemblies include a tab 102 that is integral with, or permanently fixed to, the wheel rim 103 such that a wheel cover 104 may be attached thereto. These wheel cover mounting fixtures 102 are not easily replaced or repaired if damage occurs, and may be made of heavy materials that can negatively affect performance of the vehicle. In addition, when these types of wheel cover assemblies 100 break, pieces of the wheel cover assembly 100 create a safety risk to drivers as well as bystanders, and may damage the wheel or sensitive equipment within the wheel. Such prior art wheel cover mounting fixtures are easily damaged and are not generally repairable when damage occurs.

Additionally, prior art wheel covers end near the edge of the wheel rim outer periphery and thus do not fully cover the rim of the wheel. This limiting feature may allow for debris to enter and/or build up within the wheel by entering between the rim and the wheel cover. Any intrusion or build-up of debris is particularly problematic because it can damage the wheel or inner components of the wheel, and potentially cause safety risks for a driver and others outside the vehicle.

A need exists, therefore, for a wheel cover assembly that can be adapted to fit any make and model of wheel, is removable, can be replaced easily if damaged, and can utilize lighter materials, thereby enhancing vehicle performance and minimizing safety risks. Additionally, a need exists for a wheel cover that provides better protection from debris intrusion and build-up.

### SUMMARY OF THE INVENTION

The present invention relates to an adaptable wheel cover assembly comprising one or more discrete mounting fixtures, affixed to a wheel rim such that a wheel cover can be attached to the mounting fixtures. The present invention has many advantages, including but not limited to being adaptable to fit any make and model of wheel, being easily replaced if damaged, and being able to utilize lighter materials, thereby enhancing vehicle performance and safety. The mounting fixtures may be affixed to the wheel rim by, for example, drilling a hole or a series of holes in the periphery of a wheel's rim bead seat and then fastening the mounting fixtures to the wheel through the hole or holes in the rim bead seat. Those skilled in the art will recognize that many types of fasteners can be used to affix the mounting fixtures to the wheel rim including fasteners that do not require the use of a hole, such as adhesives or magnets. In one example, a blind rivet with a flush countersunk head could be used. Preferably, fastening the mounting fixtures to the wheel rim is accomplished with fasteners that do not protrude into the original tire bead mounting profile—the area where, when mounted, the tire is firmly affixed to the wheel. Preferably, the hole or holes (if used) that affix the mounting fixtures to the wheel are sealed by the tire's bead area preventing air from escaping the tire cavity on a mounted tire/wheel combination. An embodiment of the present invention permits lightweight, quarter-turn fasteners can be used in conjunction with the mounting fixtures that can preferably be added to any non-beadlock wheel and can be installed on any manufacturer's wheel, regardless of the wheel construction or material used.

In another embodiment of the invention, a wheel cover is provided which fully covers the wheel rim. In particular, the wheel cover may extend to an outer periphery of the wheel rim lip such that the wheel cover affords better protection to the wheel and its inner components from debris intrusion and/or build-up. In an implementation, an outer diameter of the wheel cover is greater than or substantially equal to an outer diameter of the wheel rim.

In another embodiment of the invention, the method comprises the steps of (i) affixing a mounting fixtures to the periphery of a wheel's rim bead seat and (ii) affixing the wheel cover to the mounting fixtures. In another aspect of the invention, the method comprises the steps of (i) creating a hole in the periphery of a wheel's rim bead seat; (ii) aligning the mounting fixtures such that the mounting fixtures may be affixed to the wheel's rim bead seat; (iii) fastening the mounting fixtures to the wheel's rim bead seat such that fastener does not protrude into the original tire bead mounting profile; and (iv) affixing the wheel cover to the mounting fixtures.

### BRIEF DESCRIPTION OF THE DRAWINGS

FIGS. 1A and 1B show a prior art wheel cover and unitary mounting fixture.

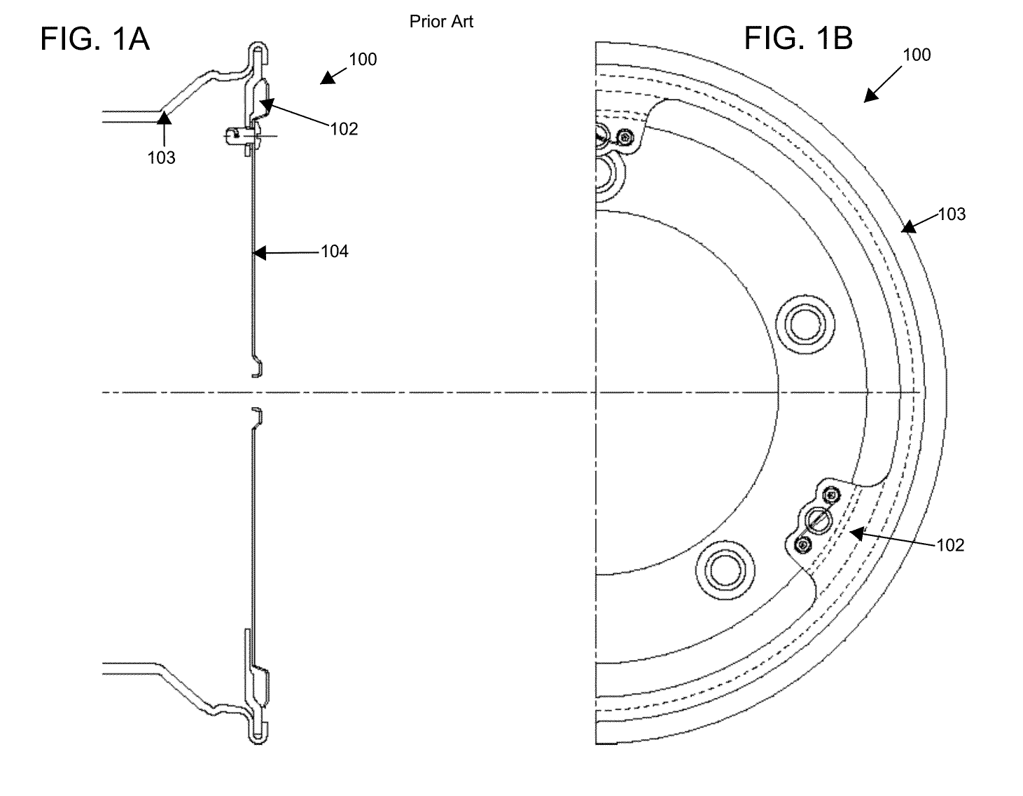

FIG. 2 shows an isometric view of an exemplary mounting fixture in accordance with an embodiment of the present invention.

FIG. 3 shows a side view of an exemplary mounting fixture in accordance with an embodiment of the present invention.

FIG. 4A shows a wheel cover assembly and FIGS. 4B-4D show alternative mounting fixtures in accordance with embodiments of the present invention.

FIGS. 5A and 5B show a wheel with mounting fixtures and wheel cover affixed in accordance with an embodiment of the present invention.

The invention is discussed and explained below with reference to the accompanying drawings. The figures are provided as an exemplary understanding of the invention and to schematically illustrate particular embodiments and details of the invention. The skilled artisan will readily recognize other similar examples equally within the scope of the invention.

### DETAILED DESCRIPTION OF THE INVENTION

To provide an overall understanding of the systems and methods described herein, certain illustrative embodiments will be described. For the purpose of clarity and illustration, these systems and methods will be described with respect to wheel cover assemblies that can be adaptively affixed to a wheel. It will be understood by one of ordinary skill in the art that the systems, devices and methods described herein may be adapted and modified as appropriate, and that these systems, devices, and methods may be employed in other suitable applications, such as for other covering assemblies, and that other such additions and modifications will not depart from the scope of invention and claims hereof.

A wheel cover assembly of the present invention utilizes one or more discrete mounting fixtures attached to the rim of a wheel such that a wheel cover may be affixed to the wheel rim via the one or more mounting fixtures. The mounting fixture may comprise a mounting tab, a clip, clamp, quarter turn fastener, or any other suitable mounting device as is known in the art, and may be affixed to the wheel rim through any suitable method known in the art. For example, one or more through-holes may be formed in the rim of the wheel such that the mounting fixture may be attached to the rim with a mechanical fastener, such as, for example, a screw, bolt, or rivet. The mounting fixture may include a base that has a curved profile. The curved profile may correspond to the curvature of the rim of a wheel. The mounting fixture may further include one or more arms extending from the base towards the center of the wheel and a front plate also extending from the base. The one or more arms and the front plate may be configured to engage a wheel cover such that the wheel cover is affixed to the mounting fixture between the one or more arms and the front plate. In one embodiment, the one or more arms and/or the front plate may be elastic. In another embodiment of the invention, the mounting fixture may include a spring member. The spring member may be fixed to the front plate and configured to secure the wheel cover .

In an embodiment of the present disclosure, the wheel cover may be configured to extend over, and cover, the outer periphery of the wheel rim. In particular, the wheel cover may completely cover the wheel by extending over the outer circumference, or lip, of the wheel rim. An outer diameter of the wheel cover may be greater than or substantially equal to an outer diameter of the wheel rim. The outer edge of the wheel cover may be shaped with a rolled and/or raised edge. Such a wheel cover may be used with any of the mounting fixture embodiments described herein to affix the wheel cover to a wheel rim.

The mounting fixture and/or wheel cover may be manufactured out of, for example, a polymer, metal, a composite, a ceramic, or any other suitable material, or combination of materials, as is known in the art. Lighter weight materials that are also strong, such as polymer reinforced carbon fiber composite, for example, may be particularly useful in high performance applications such as motor racing. In one example, the wheel cover may be manufactured by thermoforming Lexan™ polycarbonate. The mounting fixture and/or wheel cover may be manufactured using, for example, casting, machining, injection molding, 3D printing, thermoforming, or any other suitable process as is known in the art.

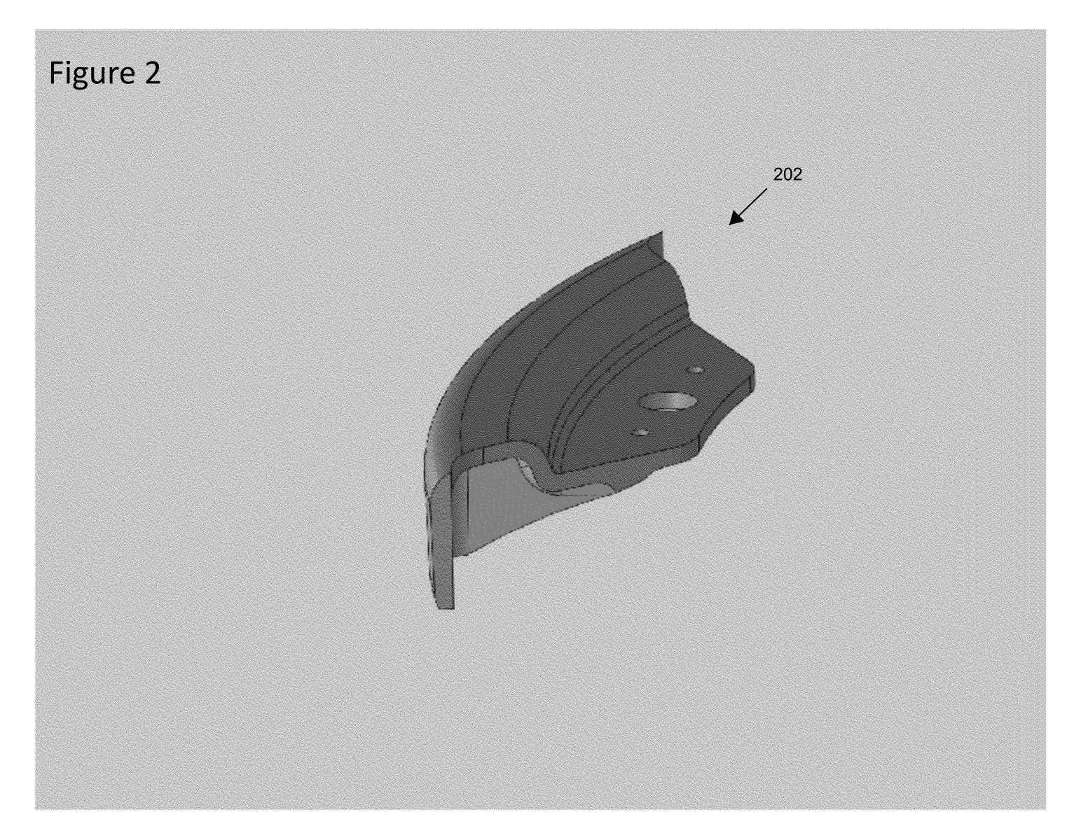

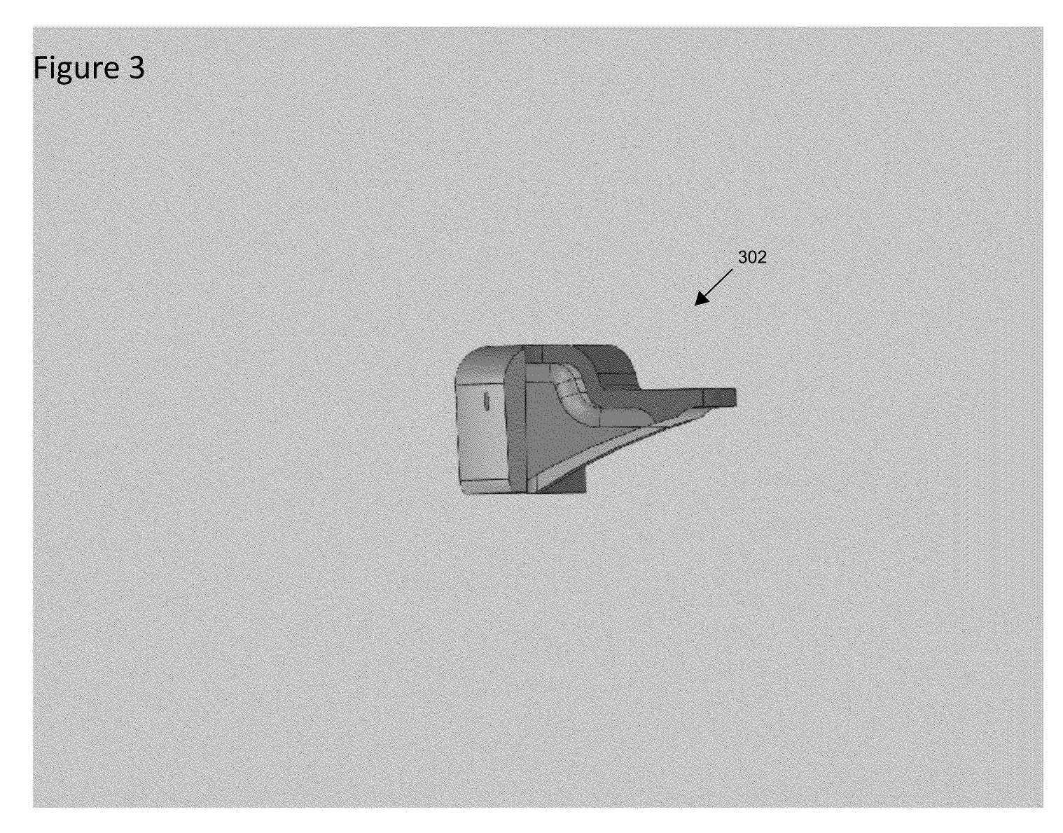

FIGS. 2 and 3 show an exemplary embodiment of a mounting fixture 202, 302 of the present invention. In this embodiment, the mounting fixture 202, 302 may be affixed to the wheel through the series of holes in the periphery of a wheel's rim bead seat and then fastening the mounting fixture 202, 302 to the wheel through the holes in the rim bead seat. Preferably, fastening the mounting fixture 202, 302 to the wheel is accomplished with fasteners that do not protrude into the original tire bead mounting profile—the area where, when mounted, the tire is firmly affixed to the wheel. Preferably, the hole or holes used to affix the mounting fixture 202, 302 to the wheel are sealed by the tire's bead area preventing air from escaping the tire cavity on a mounted tire/wheel combination. A feature of the mounting fixture 202, 302 can be secured to a wheel rim without the need to alter the wheel rim. The mounting fixture 202, 302 permits a wheel cover to be affixed thereto. It is envisioned that any number of mounting fixtures (i.e. 1, 2, 3, 4, 5 etc.) could be used depending on the structural integrity desired. The modular aspect of the present invention facilitates use on any make and model of wheel while also being removable, easily repairable and able to utilize lighter materials, thereby enhancing vehicle performance and minimizing safety risks.

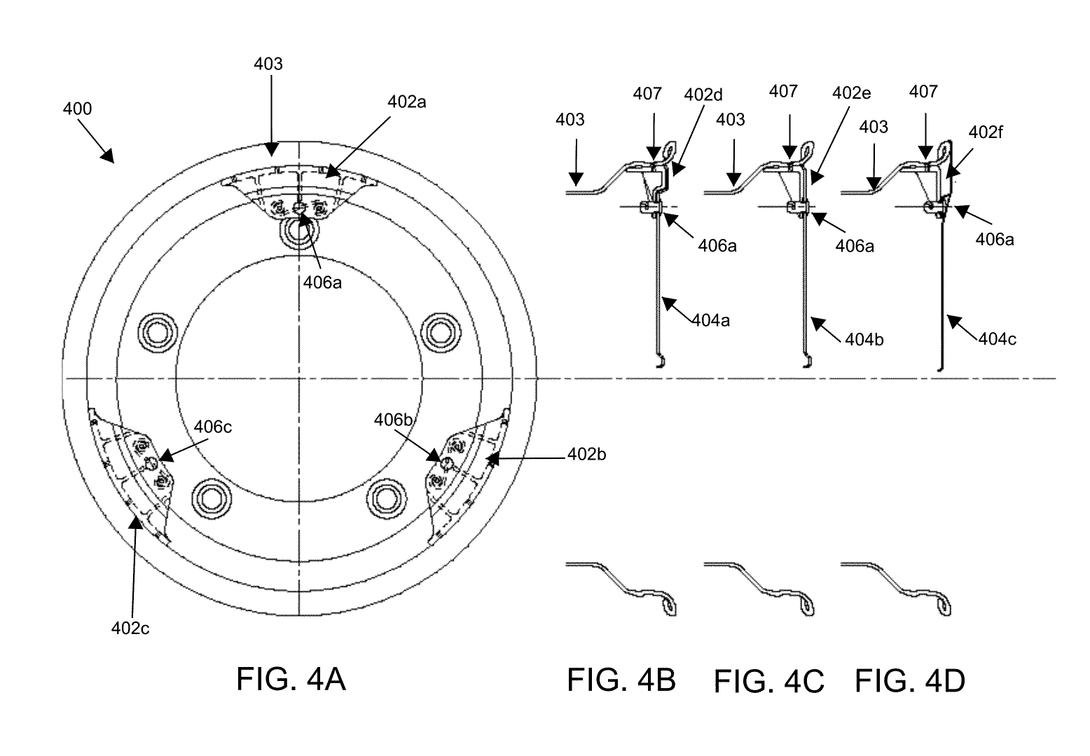

FIG. 4A shows a wheel cover assembly and FIGS. 4B-4D show alternative mounting fixture designs envisioned by the present invention. As shown in FIGS. 4A-4D, a wheel cover assembly 400 includes three mounting fixtures 402a, 402b, 402c that are equally spaced about the circumference of a wheel rim 403. However, one of skill will recognize that any number of mounting fixtures can be used with any discrete spacing between mounting fixtures to affix the wheel cover to the wheel rim 403. The mounting fixtures 402a-402c may couple to the wheel cover 404a-404c using any suitable means as is known in the art. In an example, the wheel cover 404a-404c may be coupled to the mounting fixtures 402a-402f by fasteners 406a-406c, which may be, for example, quarter turn fasteners. In another example, the wheel cover 404a-404c may be coupled to the mounting fixtures 402a-402f using other suitable means such as adhesives or magnets.

Also shown in FIGS. 4B-4D are several alternative shapes of mounting fixtures 402d-402f. The shape of the mounting fixture may be modified to facilitate connection to the wheel rim 403 or connection to the wheel cover 404a-404c. For example, as can be seen in FIG. 4B, a U-shaped mounting fixture may be used as shown by mounting fixture 402d. As can be seen in FIGS. 4C and 4D, the mounting fixtures 402e and 402f may also comprise an angle bracket, such as, for example, a 90° angle bracket. One of skill in the art will recognize that any suitable angle bracket may be used. The shape of the mounting fixture preferably facilitates connection to the wheel rim 403 for which a wheel cover 404a-404c is going to be attached. Those skilled in the art will understand that the illustrated shapes are exemplary and that any shape that facilitates connection of the mounting fixture to the wheel rim 403 and connection of the wheel cover to the mounting fixture can be used.

As stated above, the mounting fixtures 402a-402f may be affixed to the wheel rim 403 by any suitable method as is known in the art. For example, the mounting fixtures 402a-402f may be affixed to the wheel rim 403 by a fastener 407 such as a screw, bolt, or rivet placed into a through hole in the wheel rim 403. Alternatively, the mounting fixtures 402a-402f may be coupled to the wheel rim 403 by an adhesive, as is known in the art. In yet another embodiment, the mounting fixtures 402a-402f may be coupled to the wheel rim with magents.

In another embodiment, as shown in FIGS. 4B and 4C, the wheel cover 404a, 404b may be shaped to match the surface of the mounting fixture. In an example, a portion of the wheel cover 404a, 404b is substantially adjacent to at least a portion of the mounting fixtures 402a, 402b such that the wheel cover 404a, 404b rests against the mounting fixture 402d, 402e when the wheel cover 404a, 404b is fixedly attached to the mounting fixture 402d, 402e.

In a particularly useful embodiment, as shown in FIG. 4D, the wheel cover 404c may be configured to extend over, and cover, the outer periphery of the wheel rim 403. In particular, the wheel cover 404c may substantially cover the entire wheel by extending over the outer circumference, or lip, of the wheel rim 403. In such an embodiment, the outer edge of the wheel cover may be shaped with a rolled and/or raised edge. As an example, an outer diameter of the wheel cover 404c may be greater than or substantially equal to an outer diameter of the wheel rim 403. By extending the wheel cover 404c over the outer circumference of the wheel rim 403, greater protection may be afforded to the wheel and inner wheel components. Such a wheel cover 404c may provide improved protection of the wheel (and inner wheel components) from damage and prevent intrusion or excess build-up of debris within the wheel due to any gaps between the wheel rim and the wheel cover.

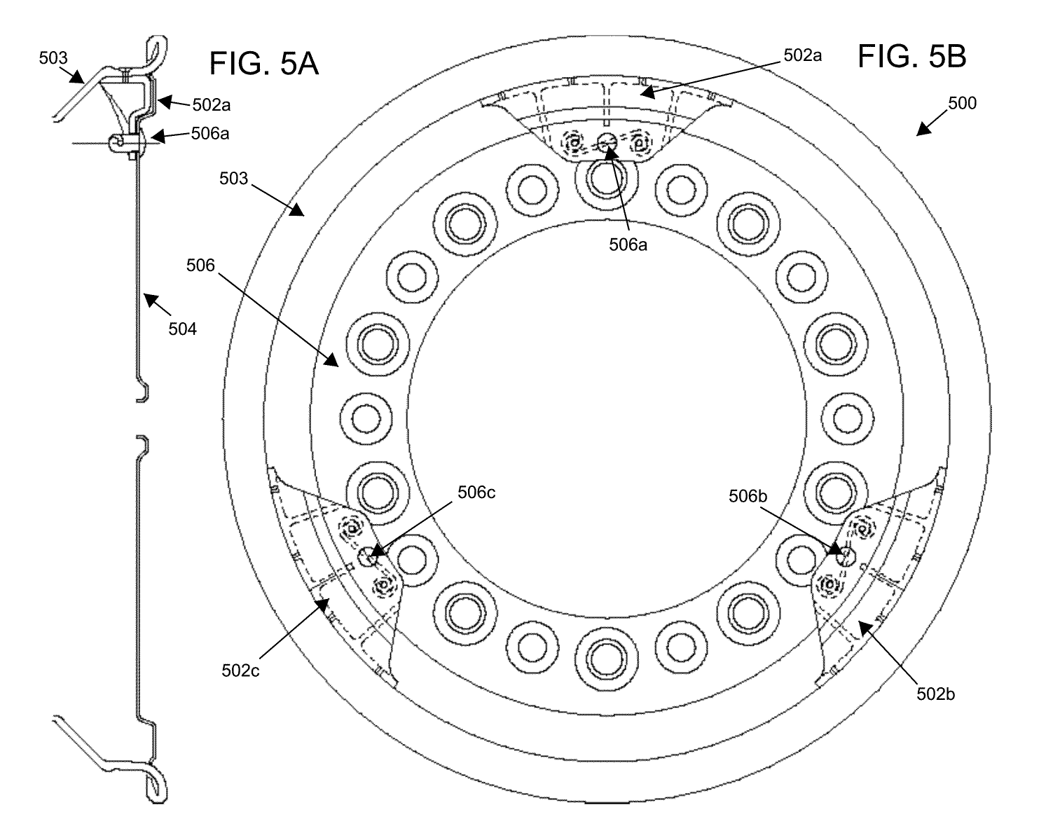

FIGS. 5A and 5B show a wheel assembly 500 including a wheel rim 503 with mounting fixtures 502a-502c and a wheel cover 504 affixed in accordance with an embodiment of the present invention. As can be seen in FIGS. 5A and 5B, three removable mounting fixtures 502a-502c are shown, however, any number of mounting fixtures can be used to affix the wheel cover 504 to the wheel rim 503. Mounting fixtures 502a-502c may be substantially similar to any of the mounting fixtures described above with respect to FIGS. 2-4D. As stated above, the mounting fixtures 502a-502c may be shaped such that they may be affixed to any make and/or model of wheel. The wheel cover 504 may be affixed to the mounting fixtures 502a-502c using, for example, quarter turn fasteners 506a-506c or any suitable fastener as is known in the art.

It will be appreciated by persons having ordinary skill in the art that many variations, additions, modifications, and other applications may be made to what has been particularly shown and described herein by way of embodiments, without departing from the spirit or scope of the invention. Therefore, it is intended that the scope of the invention includes all foreseeable variations, additions, modifications, or applications. The disclosed features may be implemented in any combination and subcombination (including multiple dependent combinations and subcombinations), with one or more other features described herein. The various features described or illustrated above, including any components thereof, may be combined or integrated in other systems. Moreover, certain features may be omitted or not implemented.

What is claimed is:

1. A wheel cover assembly comprising:
a wheel rim; and
a mounting fixture affixed to said wheel rim;
wherein said mounting fixture is detachable from said wheel rim; and
wherein said mounting fixture is suitable for affixing a wheel cover thereto.

2. The assembly of claim 1, wherein the mounting fixture is affixed to said wheel rim through a hole in the periphery of the bead seat of said wheel rim.

3. The assembly of claim 2, wherein the hole used to affix said mounting fixture to said wheel rim is sealed by the bead area so as to substantially prevent air from escaping the tire cavity.

4. The assembly of claim 1, wherein the mounting fixture is affixed to said wheel rim with fasteners that do not protrude into the bead mounting profile.

5. The assembly of claim 1, wherein the mounting fixture is affixed to said wheel rim without altering said wheel rim.

6. The assembly of claim 5, wherein the mounting fixture is affixed to said wheel rim using a blind rivet with a flush countersunk head.

7. The assembly of claim 1, wherein the mounting fixture is shaped so as to facilitate connection to the wheel rim.

8. An apparatus for affixing a wheel cover to a wheel rim; said apparatus comprising:
a mounting fixture suitable for being fastened to a wheel rim;
wherein said mounting fixture is suitable for affixing a wheel cover thereto; and
wherein said mounting fixture is detachable from said wheel rim.

9. The apparatus of claim 8, wherein the mounting fixture may be fastened to said wheel rim through a hole in the periphery of the bead seat of said wheel rim.

10. The apparatus of claim 8, wherein the mounting fixture may be affixed to said wheel rim with fasteners that do not protrude into the bead mounting profile.

11. The apparatus of claim 8, wherein the mounting fixture may be affixed to said wheel rim without altering said wheel rim.

12. The apparatus of claim 8, wherein the mounting fixture may be affixed to said wheel rim using a blind rivet with a flush countersunk head.

13. The apparatus of claim 8, further comprising a wheel cover, and wherein an outer diameter of the wheel cover is greater than or substantially equal to an outer diameter of the wheel rim.

14. A method of affixing a wheel cover to a wheel, the method comprising:
affixing a mounting fixture to the periphery of a wheel rim's bead seat; and
affixing a wheel cover to said mounting fixture.

15. The method of claim 14, wherein said step of affixing a mounting fixture to the periphery of a wheel rim's bead seat comprises:
creating a hole in the periphery of said bead seat;
aligning said mounting fixture such that the mounting fixture may be affixed to said bead seat;
fastening the mounting fixture to said bead seat such that the fastener does not protrude into the original tire bead mounting profile.

16. The method of claim 15, wherein said hole is sealed by the bead area so as to substantially prevent air from escaping the tire cavity.

17. The method of claim 14, wherein the mounting fixture is affixed to said wheel rim with fasteners that do not protrude into the bead mounting profile.

18. The method of claim 14, wherein the mounting fixture is affixed to said wheel rim without altering said wheel rim.

19. The method of claim 14, wherein the mounting fixture is affixed to said wheel rim using a blind rivet with a flush countersunk head.

20. The method of claim 14, wherein the mounting fixture is shaped so as to facilitate connection to the wheel rim.
